(19) United States
(12) Patent Application Publication
(10) Pub. No.: US 2026/0172626 A1
(43) Pub. Date: Jun. 18, 2026

(54) ELECTRONIC APPARATUS AND METHOD FOR CONTROLLING THEREOF

(71) Applicant: SAMSUNG ELECTRONICS CO., LTD., Suwon-si (KR)

(72) Inventors: Sanghun Kim, Suwon-si (KR); Donghyun Kim, Suwon-si (KR)

(73) Assignee: SAMSUNG ELECTRONICS CO., LTD., Suwon-si (KR)

(21) Appl. No.: 19/387,111

(22) Filed: Nov. 12, 2025

Related U.S. Application Data
(63) Continuation of application No. PCT/KR2025/015262, filed on Sep. 27, 2025.

(30) Foreign Application Priority Data
Dec. 17, 2024 (KR) 10-2024-0188528

(51) Int. Cl. H04N 21/4402; H04N 21/439; H04N 21/44

(52) U.S. Cl. CPC H04N 21/4402; H04N 21/4394; H04N 21/44008

(57) ABSTRACT

An electronic apparatus, including: a communication interface; one or more processors; and memory storing at least one instruction which, when executed by the one or more processors, causes the electronic apparatus to: obtain a video using the communication interface; obtain probability information for a plurality of categories by providing the video as input to a neural network model, wherein the plurality of categories includes a first category corresponding to a first genre and a second category corresponding to a plurality of genres, determine current genre information corresponding to a current video based on the obtained probability information and previous genre information corresponding a previous frame, and perform image quality processing corresponding to the genre information on the current video.

### CROSS-REFERENCE TO RELATED APPLICATIONS

This application is a continuation of International Application No. PCT/KR2025/015262 designating the United States, filed on September 27, 2025, in the Korean Intellectual Property Receiving Office and claiming priority to Korean Patent Application No. 10-2024-0188528, filed on December 17, 2024, in the Korean Intellectual Property Office, the disclosures of which are incorporated by reference herein in their entireties.

### BACKGROUND

### 1. Field

The disclosure relates to an electronic apparatus capable of adaptively adjusting image quality in a video genre and a method for controlling thereof.

### 2. Description of Related Art

An electronic apparatus may generate a video or the like corresponding to content, or perform an operation for displaying the video. Recent electronic apparatuses may carry out various image quality processing to display an obtained video more realistically.

This image quality processing may be performed by adjusting control factors such as sharpness, contrast ratio, saturation, and the like of a video, and these control factors may be applied differently according to a type of the video.

### SUMMARY

Embodiments of the disclosure may provide a solution to at least one problem and/or disadvantage described above, and provide an advantage which will be described below. Accordingly, embodiments of the disclosure may provide an electronic apparatus capable of adaptively adjusting image quality in a video genre and a method for controlling the electronic apparatus.

Additional aspects will be set forth in part in the detailed description which follows, and, in part, will be apparent from the description, or may be learned by practice of the presented embodiments.

In accordance with an aspect of the disclosure, an electronic apparatus includes: a communication interface; one or more processors; and memory storing at least one instruction which, when executed by the one or more processors, causes the electronic apparatus to: obtain a video using the communication interface; obtain probability information for a plurality of categories by providing the video as input to a neural network model, wherein the plurality of categories includes a first category corresponding to a first genre and a second category corresponding to a plurality of genres, determine current genre information corresponding to a current video based on the obtained probability information and previous genre information corresponding a previous frame, and perform image quality processing corresponding to the genre information on the current video.

The neural network model may be trained to output a probability value for each of the first category, the second category, and a third category, the first category may be associated with a first feature corresponding to the first genre, the second category may be associated with the first feature, and may be not associated with a second feature, and the third category may be not associated with the first feature and the second feature.

The first genre may include a sports genre, and the second category may be associated with at least one from among a close-up video showing a close-up of a specific person, a crowd video in which a plurality of persons are clustered, and a data graphic video.

The neural network model may be configured to categorize sport events, and the second category may be associated with different video conditions corresponding to a plurality of sport types.

The at least one instruction, when executed by the one or more processors, may further cause the electronic apparatus to: obtain additional graphic information from the video, and determine the genre information corresponding to the current video further based on a determination about whether the additional graphic information is obtained from the previous frame, and a determination about whether the additional graphic information is obtained from the current video.

The additional graphic information may include at least one from among a broadcasting company logo, a sports federation logo, and score status information at a predetermined position in the video.

The at least one instruction, when executed by the one or more processors, may further cause the electronic apparatus to: obtain audio information corresponding to the video, obtain audio characteristic information based on the audio information, and determine the genre information corresponding to the current video further based on previous audio characteristic information corresponding to the previous frame, and current audio characteristic information corresponding to the current video.

The at least one instruction, when executed by the one or more processors, may further cause the electronic apparatus to: determine a genre of the current video to be the first genre based on the probability information indicating that a first probability value corresponding to the first category is greater than or equal to a predetermined value, and maintain the genre of the current video as a previous genre corresponding to the previous frame based on the probability information indicating that the first probability value is less than the predetermined value, and that a second probability value corresponding to the second category is a highest probability value included in the probability information.

The at least one instruction, when executed by the one or more processors, may further cause the electronic apparatus to: determine the current genre information based on a modal value from among probability values associated with genres corresponding to a predetermined number of frames and a genre corresponding to a highest probability value included the probability information.

The electronic apparatus may further include: a display, and the at least one instruction, when executed by the one or more processors, may further cause the electronic apparatus to: control the display to display the processed video.

In accordance with an aspect of the disclosure, a control method of an electronic apparatus includes: obtaining, by providing a video as input to a neural network model, probability information for a plurality of categories including a first category corresponding to a first genre and a second category corresponding to a plurality of genres; determining genre information corresponding to a current video based on the probability information and genre information of a previous frame; and performing image quality processing corresponding to the genre information on the current video.

The neural network model may be trained to output probability values for each of the first category, the second category, and a third category, the first category may be associated with a first feature corresponding to the first genre, the second category may be not associated with the first feature, and may be associated with a second feature, and the third category may be not associated with the first feature and the second feature.

The first genre may include a sports genre, and the second category may be associated with at least one from among a close-up video showing a close-up of a specific person, a crowd video in which a plurality of persons are clustered, and a data graphic video.

The method may further include: obtaining additional graphic information from the video, and wherein the genre information is further obtained based on a determination about whether the additional graphic information is obtained from the previous frame, and a determination about whether the additional graphic information is obtained from the current video.

In accordance with an aspect of the disclosure, a non-transitory computer-readable recording medium stores programs for executing a control method of an electronic apparatus, including: obtaining, by providing a video as input to a neural network model, probability information for a plurality of categories including a first category corresponding to a first genre and a second category corresponding to a plurality of genres; determining genre information corresponding to a current video based on the probability information and genre information of a previous frame; and performing image quality processing corresponding to the genre information on the current video.

### BRIEF DESCRIPTION OF THE DRAWINGS

Aspects, features, and advantages described above or different from embodiments of the disclosure will be made clearer from the descriptions described below with reference to the accompanied drawings. In the accompanied drawings:

FIG. 1 is a diagram illustrating a content recommendation operation according to an embodiment of the disclosure;

FIG. 2 is a block diagram illustrating a configuration of an electronic apparatus according to an embodiment of the disclosure;

FIG. 3 is a block diagram illustrating a configuration of an electronic apparatus according to an embodiment of the disclosure;

FIG. 4 is a diagram illustrating a categorization method according to an embodiment of the disclosure;

FIG. 5 is a diagram illustrating category items according an embodiment of the disclosure;

FIG. 6 is a diagram illustrating a categorization method according to an embodiment of the disclosure;

FIG. 7 is a diagram illustrating category examples according to an embodiment of the disclosure;

FIG. 8 is a diagram illustrating a categorization method according to an embodiment of the disclosure; and

FIG. 9 is a flowchart illustrating a control method of an electronic apparatus according to an embodiment of the disclosure.

### DETAILED DESCRIPTION

Various modifications may be made to the embodiments of the disclosure, and there may be various types of embodiments. Accordingly, specific embodiments are illustrated in drawings, and described in detail in the detailed description. However, it should be noted that the various embodiments are not for limiting the scope of the disclosure to a specific embodiment, but they should be interpreted to include all modifications, equivalents or alternatives of the embodiments included in the ideas and the technical scopes disclosed herein. With respect to the description of the drawings, like reference numerals may be used to indicate like elements.

In describing the disclosure, if it is determined that the detailed description of related known technologies may unnecessarily obscure or confuse the disclosure, the detailed description thereof may be omitted.

Further, the particular embodiments below may be modified to various different forms, and it is to be understood that the scope of the technical spirit of the disclosure is not limited to the embodiments below. Rather, the particular embodiments are provided so that the disclosure is thorough and complete, and to fully convey the technical spirit of the disclosure to those skilled in the art.

Terms used herein have merely been used to describe a specific embodiment, and not to limit the scope of protection. A singular expression includes a plural expression, unless otherwise specified.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

In the disclosure, expressions such as “A or B”, “at least one of A and/or B”, or “one or more of A and/or B” may include all possible combinations of the items listed together. For example, “A or B”, “at least one of A and B”, and “at least one of A or B” may refer to all cases including (1) at least one A, (2) at least one B, or (3) both of at least one A and at least one B.

Expressions such as “1st”, “2nd”, “first”, or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), this may be understood as the certain element being directly coupled with/to the another element, or as coupled through other element (e.g., a third element).

However, when the certain element (e.g., first element) is indicated as “directly coupled with/to” or “directly connected to” the another element (e.g., second element), this may be understood as the other element (e.g., third element) being not present between the certain element and the another element.

The expression “configured to… (or set up to)” used in the disclosure may be used interchangeably with, for example, “suitable for…”, “having the capacity to…”, “designed to…”, “adapted to…”, “made to…”, or “capable of…” based on circumstance. The term “configured to… (or set up to)” may not necessarily mean “specifically designed to” in terms of hardware.

Rather, in a certain circumstance, the expression “a device configured to…” may mean something that the device “may perform…” together with another device or components. For example, a phrase “a sub-processor configured to (or set up to) perform A, B, or C” may mean a dedicated processor for performing a relevant operation (e.g., an embedded processor), or a generic-purpose processor (e.g., a central processing unit (CPU) or an application processor) capable of performing the relevant operations by executing one or more software programs stored in a memory device.

The term ‘module’ or ‘part’ used in the embodiments herein perform at least one function or operation, and may be implemented with hardware or software, or implemented with a combination of hardware and software. In addition, a plurality of ‘modules’ or a plurality of ‘parts’, except for a ‘module’ or a ‘part’ which needs to be implemented with a specific hardware, may be integrated in at least one module and implemented as at least one processor.

Operations performed by a module, a program, or other element, in accordance with the various embodiments, may be executed sequentially, in parallel, repetitively, or in a heuristic manner, or at least a portion of the operations may be performed in a different order, omitted, or a different operation may be added.

Various elements and areas of the drawings have been schematically illustrated. Accordingly, the technical spirit of the disclosure is not limited by relative sizes and distances illustrated in the accompanied drawings.

An electronic apparatus according to various embodiments of the disclosure may include at least one from among, for example, a smart phone, a tablet personal computer (PC), a desktop PC, a laptop PC, a server, or a wearable device. The wearable device may include at least one from among an accessory type (e.g., a watch, a ring, a bracelet, an anklet, a necklace, a pair of glasses, a contact lens or a head-mounted-device (HMD)), a fabric or a garment-embedded type (e.g., an electronic clothing), a skin-attached type (e.g., a skin pad or a tattoo), or a bio-implantable circuit.

In some embodiments, the electronic apparatus may include at least one from among, for example, and without limitation, a television, a digital video disk (DVD) player, an audio, a refrigerator, an air conditioner, a cleaner, an oven, a microwave, a washing machine, an air purifier, a set top box, a home automation control panel, a security control panel, a media box (e.g., SAMSUNG HomeSync^{TM}, APPLE TV^{TM}, or GOOGLE TV^{TM}), a game console (e.g., Xbox^{TM}, PlayStation^{TM}), an electronic dictionary, an electronic key, a camcorder, an electronic frame, and the like. According to embodiments, a device that includes a display from among the above-described electronic devices may be referred to as a display device. In addition, the electronic apparatus according to embodiments of the disclosure may be the set top box or PC that provides a video to the display device even if a display is not included.

Embodiments of the disclosure are described in detail with reference to the accompanying drawings below to aid in the understanding of those of ordinary skill in the art.

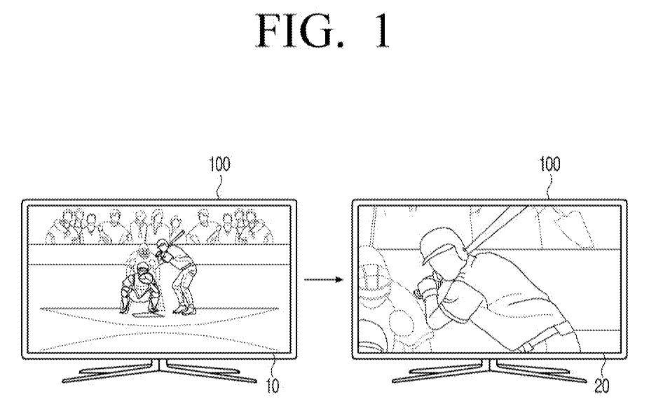

FIG. 1 is a diagram illustrating a content recommendation operation according to an embodiment of the disclosure.

Referring to FIG. 1, an electronic apparatus 100 may display content selected by a user. Here, content may be a movie, a music, a play, a photograph, a cartoon, an animation, a computer game, a character, a figure, colors, a speech, a motion, or a picture, or providing a combination of the above-described items through the electronic apparatus.

The electronic apparatus 100 may correct, based on a genre of the content selected by the user being a sports genre, a video to match the sports genre, and display the corrected video.

Here, the genre may refer to a category in which various content such as literature, arts, and movies are categorized according to a specific criterion. Accordingly, genre of a content may be categorized into sports, movies, drama, animation, news, and the like. According to embodiments, the genre of a content may be used to perform image processing (or image quality processing) or sound processing suitable to the genre. Accordingly, there is greater interest in whether the categories are classified by specific genre (e.g., sports genre) rather than classifying the content genre individually.

The electronic apparatus 100 may use features associated with the sports genre to identify or determine whether a current video corresponds to a sports genre. For example, a first screen 10 may have a composition in which a batter, a catcher, and an umpire, which may be commonly seen in a baseball game. Accordingly, the electronic apparatus 100 may determine that the current video is associated with the sports genre when such a composition is identified in the video. As another example, because sports such as soccer (or football) may be performed over green grass, the electronic apparatus may determine that the video is associated with the sports genre based on identifying or detecting a plurality of people handling a ball over green grass in the video. However, this is only an example, and features corresponding to a sports genre are not limited thereto. For example, other features may be obtained through learning based on various sport videos.

However, the same video may also include video features that may difficult to use for determining the sports genre. As a result, it may be difficult to identify the sports genre based only on scenes that frequently appear in the sports genre or features of a relevant scene. For example, the video may include a screen such as a second screen 20 showing a close-up screen of a specific player as in a second screen 20, a screen in which the crowd is displayed, a screen in which graphic information is displayed, a screen in which an intermission advertisement is displayed, and the like.

Some screens that frequently appear in sport videos may include compositions and/or features that are frequently are also frequently found in other genres such as the news, movies, and dramas, and not just in the sports genre. Accordingly, if a screen showing a close-up screen of a specific person is identified and categorized as the sports genre, a video including close-up screen of a specific person in genres such as news, movies, and drama may be misidentified as corresponding to the sports genre.

Based on the above, according to some approaches, close-up screens or screens showing crowds may be categorized as other genre rather than the sports genre.

A categorization method according to these approaches may have an advantage in that a close-up screen of a specific person in genres such as news, movies, and the like as may not be categorized as the sports genre, but also may have a disadvantage in that scenes including close-up screens in the sports may not be recognized as the sports genre.

For example, the electronic apparatus may process a screen brightness of a video corresponding to the sports genre as a first brightness which is relatively high (e.g., relatively bright), but when a close-up screen of a specific playing is maintained for a certain time, or a screen of the crowd is maintained for a certain time, the electronic apparatus may determine that it the video does correspond to the sports genre. Accordingly, the electronic apparatus may process the brightness of the screen to have a second brightness which is relatively lower (e.g., relatively darker) than the previous screen. Then, if the screen is determined as the sports genre again based on a subsequent screen, the screen brightness may be processed back to the first brightness. Therefore, despite continuously viewing the same sports content as described above, if an image quality processing method is frequently changed, this may hinder viewing of the video.

Accordingly, even while displaying the above-described situations associated with a sports game such as a close-up screen of a specific player being shown or the crowd being shown, it is beneficial to consistently recognize the video as corresponding to a sports genre. In addition, when the above-described close-up screen is shown, or a screen including a plurality of crowds is identified in content such as the news, it is beneficial to not identify the video as corresponding to the sports genre.

Accordingly, taking the above into consideration, embodiments may identify a close-up screen, a crowd screen, a graphic image, and the like, as separate items, and may analyze or determine the final genre of the video by considering a previous identification result when such items are identified.

For example, if a previous screen corresponds to the sports genre, and a current screen is identified as corresponding to a close-up genre, the current genre of the video may be identified by maintaining the sports genre which is the previous category. As another example, if the previous screen corresponds to the news genre, and the current screen is identified as corresponding to the close-up genre, the current genre of the video may be determined by maintaining the news genre which is the previous category.

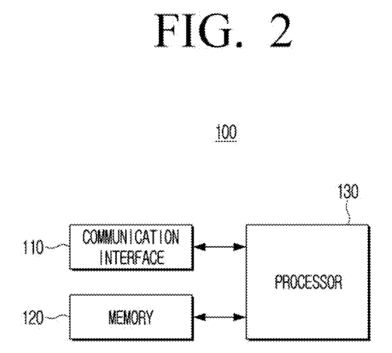

An example of a detailed configuration and operation of the above-described electronic apparatus 100 according to embodiments of the disclosure is described below with reference to FIG. 2.

As described, because the electronic apparatus according to embodiments of the disclosure may categorize the close-up video, the crowd video, and the graphic video as separate items, and the electronic apparatus may analyze or determine the final genre using the relevant items with previous categorization results (e.g., previous analysis results or previous determination results), a more accurate and consistent genre analysis may be performed. Then, the electronic apparatus may perform an accurate and consistent image quality processing on the video based on the accurate genre analysis.

In the description of FIG. 1 above, although examples are described in which the electronic apparatus directly displays a video, embodiments are not limited thereto. For example, in some embodiments, the electronic apparatus may not include a display, and output the video to a different device.

FIG. 2 is a block diagram illustrating a configuration of an electronic apparatus according to an embodiment of the disclosure.

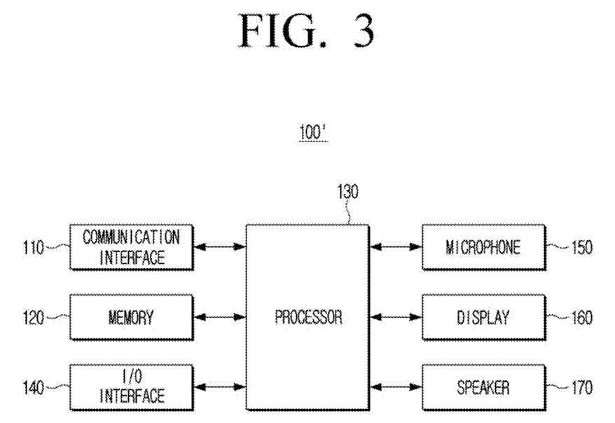

Referring to FIG. 2, the electronic apparatus 100 may include a communication interface 110, a memory 120, and a processor 130. As described, the electronic apparatus 100 may be, or may include, at least one of a server, a set top box, a TV, and the like. An example of collecting and using information such as a viewing history of a different apparatus is described below in association with the apparatus of FIG. 2, and an example of directly storing and managing the viewing history is described below in association with the apparatus of FIG. 3.

The communication interface 110 may be configured to perform communication with external devices of various types according to communication methods of various types. The communication interface 110 may include a wired communication module, a Wi-Fi module, a Bluetooth module, an infrared communication module, a wireless communication module, and the like. Here, each communication module may include at least one hardware chip or hardware circuitry.

The Wi-Fi module and the Bluetooth module may perform communication according to a Wi-Fi method and a Bluetooth method, respectively. When using the Wi-Fi module or the Bluetooth module, various connection information such as a service set identifier (SSID) and a session key may first be transmitted and received, and after communicatively connecting using the same, various information may be transmitted and received.

The infrared communication module may perform communication according to an infrared communication (Infrared Data Association (IrDA)) technology of transmitting data wirelessly in short range by using infrared rays present between visible rays and millimeter waves.

The wireless communication module may include at least one communication chip that performs communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods.

In addition, the communication interface 110 may include at least one from among wired communication modules that perform communication using a local area network (LAN) module, an Ethernet module, or a pair cable, a coaxial cable, an optical fiber cable, an Ultra Wide-Band (UWB) module, and the like.

The communication interface 110 may receive content. For example, the content may include at least one of movies, music videos, dramas, shorts videos, and the like. Further, the content may be, or may include, at least one of a video, a game content, and the like.

The communication interface 110 may obtain content information corresponding to content. For example, content information may include field information and metadata. For example, an example of a video analysis described below may utilize the above-described content information in addition thereto and not just perform a screen analysis.

According to embodiments, the screen may be, or may include, an image displayed on the display of the electronic apparatus. The image may be referred to as a frame. On the screen, objects of various types such as icons, texts, pictures, videos, widgets, and the like may be displayed.

In addition to content, the communication interface 110 may also receive information and the like used by various applications of the electronic apparatus 100, and information for providing a service from an external device.

The memory 120 may be implemented as at least one of internal memory such as a read only memory (ROM) (e.g., an electrically erasable programmable read-only memory (EEPROM)), a random access memory (RAM), and the like included in the processor 130, and memory separate from the processor 130. For example, the memory 120 may be implemented in at least one of a form of memory embedded in the electronic apparatus 100 according to data storage use, and a form of memory attachable to or detachable from the electronic apparatus 100. For example, data for driving the electronic apparatus 100 may be stored in the memory embedded in the electronic apparatus 100, and data for an expansion function of the electronic apparatus 100 may be stored in the memory attachable to or detachable from the electronic apparatus 100.

The memory 120 may store probability information generated in a process described below, an identification result, and the like. Accordingly, the memory 120 may store information about probability information within a certain time period (e.g., ten (“10”) seconds) or the final genre.

Then, the memory 120 may store content, metadata, and the like received using the above-described communication interface 110. In addition, the memory 120 may temporarily store an image quality processed video.

According to embodiments, the memory embedded in the electronic apparatus 100 may be implemented as at least one of a volatile memory (e.g., at least one of a dynamic RAM (DRAM), a static RAM (SRAM), and a synchronous dynamic RAM (SDRAM)), and a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard disk drive (HDD), and a solid state drive (SSD)). and the memory attachable to or detachable from the electronic apparatus 100 may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., USB memory) connectable to a USB port, and the like.

Although examples are described in which the electronic apparatus 100 is described as being configured with one memory, embodiments are not limited thereto. For example, when distinguishing and referring to the volatile memory and the non-volatile memory, the electronic apparatus 100 may be referred to as including a plurality of memories.

The processor 130 may perform an overall control operation of the electronic apparatus 100. For example, the processor 130 may function controlling the overall operation of the electronic apparatus 100.

The processor 130 may be implemented as a digital signal processor (DSP), a microprocessor, and a time controller (TCON) for processing digital signals. However, the embodiment is not limited thereto, and may include one or more from among a central processing unit (CPU), a micro controller unit (MCU), a micro processing unit (MPU), a controller, an application processor (AP), a graphics-processing unit (GPU), a communication processor (CP), and an ARM processor, or may be defined by the relevant term. In addition, the processor 130 may be implemented as a System on Chip (SoC) or a large scale integration (LSI) in which a processing algorithm is embedded, and may be implemented in a form of a field programmable gate array (FPGA). In addition, the processor 130 may perform various functions by executing computer executable instructions stored in the memory. Although the example illustrated in FIG. 2 includes only one processor, embodiments are not limited thereto, and a plurality of processors (e.g., CPU and GPU, or a CPU and DSP) may be included at implementation.

The processor 130 may obtain content using the communication interface 110. For example, the processor 130 may obtain information about content which the electronic apparatus 100 is able to provide.

The content that the aforementioned electronic device can provide may include content stored and provided directly by the electronic device itself, and also content downloaded and displayed by another device, such as through a mirroring method.

The processor 130 may first obtain probability information for a plurality of categories including a first category corresponding to a first genre and a second category corresponding to a plurality of genres by providing a video as input to a neural network model. For example, the second category may be a category that is not always categorized as the first genre, but has a possibility to be categorized as the first genre.

For example, the neural network model may be a model trained to output probability values for each of a first category that is associated with a first feature corresponding to a first genre, a second category that has a possibility of belonging to a first genre but is not associated with the first feature and is associated with a second feature, and a third category that is not associated with the first feature or the second feature.

Here, the first genre (e.g., a sports genre) may further include subgenres or subcategories, including close-up videos of specific individuals, crowd scenes, or data graphic videos. Accordingly, the above-described first feature may be a feature for identifying or distinguishing various sports, and may be, for example, detection of a grass environment for soccer, a composition of a home plate for baseball, a composition of a batter and a catcher being disposed, and the like. Here, the cluster may mean a gathering of people whose faces can be recognized, and the crowd may mean a gathering of a plurality (e.g., dozens or hundreds) of people whose individual faces cannot be recognized.

Although examples are described above in which the first genre is a sports genre, the same may be applicable for other genres in addition to the sports genre at implementation. For example, the first genre may be a gaming genre, a music broadcast genre, a movie genre, and the like. In addition, at implementation, metadata of current content may be used to identify the first genre.

Here, the neural network model may be a computing system implemented based on a neural network of a brain of a human or an animal, and may be referred to as a training model, a machine learning model, an artificial intelligence model, a deep learning model, and the like. For example, the training model may be implemented as a Convolutional Neural Network (CNN), a Long Short-Term Memory (LSTM), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), and the like, but embodiments are not limited thereto.

The processor 130 may obtain genre information of a current video based on the obtained probability information and genre information of a previous frame. For example, the processor 130 may determine that the current video corresponds to the first genre based on probability information corresponding to the first category being greater than or equal to a predetermined value, and may maintain the genre determined from the previous frame based on probability information corresponding to the first category being less than the predetermined value and a probability value corresponding to the second category being the highest from among probability values included in the obtained probability information.

In some embodiments, the processor 130 may determine the genre a modal value (e.g., a mode) from among probability values of genres corresponding to each of a predetermined number of frames and genres corresponding to the highest probability value from included in the obtained probability information as a genre. For example, the processor 130 may determine the current genre based on a determination result associated with a certain time.

According to embodiments, time information and use methods may be variously applied. For example, if the prior determination result (e.g., the determination result just prior to the current time) is the sports genre, the processor 130 may use the modal value for ten (“10”) seconds. However, for example, if the prior determination result is not determined as the sports genre (e.g., if it is an advertisement display period), the processor 130 may use the modal value for a relatively short time (e.g., one (“1”) second to three (“3”) seconds), or directly determine as the sports genre based on the determination result for the current video being the sports genre.

The processor 130 may further obtain additional graphic information from a video, and obtain genre information about the current video based on the obtained probability information and genre information of a previous frame, whether the additional graphic information is obtained from the previous frame, and whether the additional graphic information is obtained from the current video.

For example, the processor 130 may use the above-described additional graphic information in the video, and also information (e.g., metadata) associated with content. However, because the metadata may not be used at a time-point at which advertisement appears while a specific program is underway, genres based on the metadata may be used to determine the first genre.

Although examples are described above in which the additional graphic information is considered in a separate step, embodiments are not limited thereto. For example, in some embodiments, the network for genre analysis described above may perform genre analysis while taking the additional graphic information into account. Here, the additional graphic information may include at least one from among a broadcasting company logo, a sports federation logo, and a score status information positioned at a predetermined position of a video.

The processor 130 may carry out a final categorization by additionally using audio information. For example, the processor 130 may obtain audio information corresponding to a video. As an example, the processor 130 may obtain audio data corresponding to a current video from content. In some embodiments, the processor 130 may obtain sound data transferred to a speaker rather than content.

The processor 130 may obtain audio characteristic information based on audio information. For example, the processor 130 may check components by frequency through a frequency analysis of audio information.

The processor 130 may obtain genre information corresponding to a current video based on the obtained probability information and genre information of a previous frame, audio characteristic information from the previous frame, and audio characteristic information corresponding to the current video. For example, because a content may be considered to be a same content being played continuously if a high cheering sound is continuously maintained, the processor 130 may determine that the genre of the previous screen is being maintained if the above-described audio characteristic is similar.

Although examples are described in which a genre of a current screen is determined using specific information which is the above-described operation, the above-described operation may be differently described. For example, the processor 130 may determine whether to maintain the prior genre using the above-described information, or whether to identify it as the genre being changed.

Although examples are described which relate to distinguishing whether a video is a sports video or another video, embodiments are not limited thereto. For example, some embodiments may relate to distinguishing whether the video is a main video (e.g., a content video) or an advertisement video. In other words, electronic apparatus may identify a genre of the current content based on the metadata, and may perform image quality processing corresponding to the relevant genre. The processor 130 may determine whether the current video is a continuance of the sports video, or whether the sports video has been converted to the advertisement video, using video categories, and the like as described above.

For example, while a user is viewing a sports video, if a game logo was displayed in the previous video but is not displayed in the current video, and if the current video frame is distinguished as a third category rather than the first category and second category, it may be determined that the sports video has been converted to the advertisement video.

However, after the advertisement video is confirmed, the processor 130 may immediately determine the video to be the sports video again if the game logo is detected in the video and a probability value of the first category is a relatively high value.

Then, the processor 130 may perform image quality processing corresponding to the obtained genre information with respect to the current video. For example, if the obtained genre is the sports genre, the processor 130 may perform image quality processing corresponding to the sports genre. The processor 130 may not perform a separate additional image quality processing if the obtained genre is the movie genre, or may perform only the image quality processing predetermined by the user. In addition, if the obtained genre is the gaming genre, the processor 130 may perform image quality processing using a method capable of image quality processing at a fast rate rather than image quality processing of a high quality.

Here, the image quality processing may be, or may include, a process for improving or adjusting image quality of an image or a video, and may include improving visual quality of the video or image by utilizing various algorithms. For example, the image quality processing may include a processing for improving resolution, a processing for removing noise, a processing for correcting color and contrast, a processing for removing blurring, a processing for restoring compression loss, a processing for adding special effects, and the like.

Although examples are described above which relate to image quality processing, embodiments are not limited thereto. For example, in some embodiments, additional image quality processing corresponding to a relevant genre may not be performed with respect to a specific genre, and only audio processing corresponding to the relevant genre below may be carried out. For example, for music-centric content such as music broadcasts, instrumental performances, and orchestras, audio processing may be mainly carried out rather than image quality processing.

In addition, the processor 130 may perform audio processing corresponding to the obtained genre information for even current audio data. For example, if the current screen is a sports screen, the processor 130 may perform audio processing to output a more realistic (e.g., more three-dimensional) sound. If a type of sport can be distinguished, the processor 130 may perform audio processing corresponding to the sport type. For example, different sound processing may be carried out for sports performed indoors and sports performed outdoors, or a sense of three-dimensionality corresponding to a sports stadium may be added. For example, for sports performed in very large areas such as rugby and soccer (or football), a sense of three-dimensionality corresponding to a size of a relevant stadium is added, and for sports performed in small areas such as table tennis, fencing, and the like, sound processing may be carried out so as to have a sense of three-dimensionality corresponding to the size thereof.

The electronic apparatus 100 according to an embodiment as described above may identify a close-up video, a crowd video, and a graphic video as separate items, and if a current video is recognized as corresponding to the relevant item, may finally determine the genre by taking into reference a previous identification result. Accordingly, a more accurate and consistent genre analysis may be possible and thereby, a more accurate and consistent image quality processing may be performed.

In the examples described above, a relatively simple configuration of the electronic apparatus 100 is shown and described, but at implementation, other configurations may be provided in addition thereto, some examples of which are described below with reference to FIG. 3.

FIG. 3 is a block diagram illustrating a configuration of an electronic apparatus according to an embodiment of the disclosure.

Referring to FIG. 3, an electronic apparatus 100’ may include the communication interface 110, the memory 120, the processor 130, an input/output (I/O) interface 140, a microphone 150, a display 160, and a speaker 170.

According to embodiments, the communication interface 110, the memory 120, and the processor 130 may be the same as, or similar to, those described with reference to FIG. 2 above. Accordingly, redundant or duplicative description thereof may be omitted.

The I/O interface 140 may be an interface of any one from among a High Definition Multimedia Interface (HDMI), a Mobile High-Definition Link (MHL), a Universal Serial Bus (USB), a Display Port (DP), Thunderbolt, a Video Graphics Array (VGA) port, an RGB port, a D-subminiature (D-SUB), and a Digital Visual Interface (DVI).

The I/O interface 140 may input and output at least one from among audio and video signals. According to an implementation, the I/O interface 140 may include a port for inputting and outputting only audio signals and a port for inputting and outputting only video signals as separate ports, or may be implemented as one port that inputs and outputs both audio signals and video signals.

Then, the I/O interface 140 may provide or transmit video signals corresponding to a screen generated in the electronic apparatus 100’ or audio signals together with the relevant video signals to an external device (e.g., display device, STB, etc.). For example, the video signals that are transmitted may be image quality processed in a method corresponding to the genre of the relevant screen.

The microphone 150 may receive or detect a user speech in an activated state. For example, the microphone 150 may be formed as an integrated-type integrated to at least one of an upper side direction, a front surface direction, a side surface direction, and the like, of the electronic apparatus 100’. The microphone 150 may include various configurations such as a microphone configured to collect the user speech in analog form, an amplifier circuit configured to amplify the collected user speech, an A/D converter circuit configured to sample the amplified user speech and convert the sampled user speech to digital signals, a filter circuit configured to remove noise components from the converted digital signals, and the like.

When the user speech is input through the microphone 150 described above, the processor 130 may check a speech content of the user, and perform an operation corresponding to the speech content. For example, the speech content herein may be a command for changing content (or channel), a command for changing an image quality processing method, and the like.

Although examples are described above in which the user speech is input through the microphone 150, embodiments are not limited thereto. For example, the microphone may be provided in a remote controller for controlling the electronic apparatus 100’, and the user speech input through the microphone that is provided in the remote controller may be input and processed in the electronic apparatus 100’ through the above-described communication interface 110.

The electronic apparatus 100’ may operate based on the configurations provided in the electronic apparatus 100’ or the remote controller, and may also operate according to a control command of a terminal device. For example, if the electronic apparatus 100’ is the TV or the set top box, manufacturers have recently been providing applications for controlling the TV or the set top box. The applications as described may provide a function allowing for terminal devices to be used as remote controllers for relevant electronic apparatuses.

Accordingly, in order for the user to control the TV or the set top box using the terminal device, an application may be executed, and if the user inputs a speech command through the terminal device, the electronic apparatus 100’ may perform a speech recognition operation using the speech signals input through the terminal device and a speech identification result corresponding thereto.

Here, the speech recognition may include a process of converting the user speech to a form that may be processed by the electronic apparatus 100’. For example, the speech recognition may include converting acoustic speech signals of the speech obtained by the electronic apparatus 100’ to text such as words or sentences, and may be referred to as computer speech recognition or speech to text (STT).

The display 160 may be implemented as displays of various forms such as, for example, and without limitation, at least one of a liquid crystal display (LCD), an organic light emitting diode (OLED) display, a plasma display panel (PDP), and the like. In the display 160, a driving circuit, which may be implemented in a form of at least one of an a-si TFT, a low temperature poly silicon (LTPS) TFT, an organic TFT (OTFT), and the like, a backlight unit, and the like may be included together therewith. According to embodiments, the display 160 may be implemented as at least one of a touch screen coupled with a touch sensor, a flexible display, a three-dimensional display (3D display), and the like.

The display 160 may display various videos. For example, the display 160 may display a video which was image quality processed in the processor 130. According to embodiments, if image quality processing of a specific genre involves brightness value adjustment, and the like, the display 160 may receive setting information such as brightness information corresponding to the above-described image quality processing. Based on the above-described setting information, the display 160 may display a video by adjusting a backlight operation, or changing a state of brightness.

The speaker 170 may output sound. For example, the speaker 170 may be an element that outputs various audio data processed in the input and output interface, and also various notification sounds, speech messages, and the like. Further, the speaker 170 may output result information (e.g., information on a recommended content) corresponding to the speech recognition operation, an example of which is described below. As described, the sound output from the speaker 170 may be sound processed based on the genre in the processor 130.

FIG. 3 illustrates an example in which the electronic apparatus 100’ includes the display 160, but embodiments are not limited thereto. For example, if the electronic apparatus 100’ is a device such as the set top box which does not include a display, the display configuration may be omitted. In addition, the above-described speaker and the microphone may also be omitted according to a form of implementation. In addition, other configurations (e.g., a camera, etc.) may be further included.

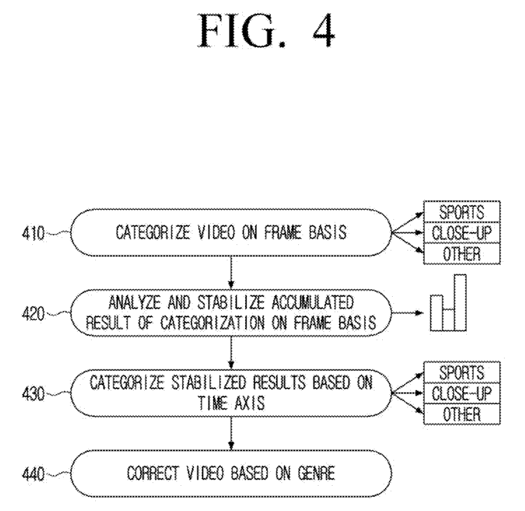

FIG. 4 is a diagram illustrating a categorization method according to an embodiment of the disclosure.

Referring to FIG. 4, an electronic apparatus (e.g., at least one of the electronic apparatus 100 and the electronic apparatus 100’) may provide a current video as input to the neural network model, and may obtain the probability information at operation 410. As shown in FIG. 4, the neural network model may output probability information for each of the first category, the second category, and the third category. According to embodiments, operation 410 may be performed for each frame on a frame basis (e.g., frame by frame, or for each frame of the video).

Here, the first category may correspond to sports videos, the second category may correspond to close-up videos, and the third category may be other videos that do not correspond to the first category and the second category. Although examples are described which relate to three categories, embodiments are not limited thereto. For example, in some embodiments, two categories may be used, or four or more categories may be used. In addition, rather than categorizing as sports in general, the neural network model may distinguish individual sporting events or types of sports (e.g., baseball, soccer, volleyball, American football, etc.) and output probabilities for each sporting event or type of sport.

As an example, the neural network model may output probability values that reflect at least one of stadium features, clothing, and the like associated with a specific game being included in the video such as the importance of green in the video and whether white lines are disposed, and that has a highly likelihood of the relevant video belonging to the sports genre.

The second category may correspond to a close-up screen of a specific person being disposed in most of the video. For example, there are instances in which a close-up screen of a specific player is displayed in a sports genre. However, although the close-up screen may be included in the sports genre, it may be a screen which may be used in other genres as described above.

The electronic apparatus may continuously accumulate and record output results of the neural network model described in the memory at operation 420. For example, the analysis as described above may be carried out four times for every second, and the electronic apparatus may continuously manage output results within a certain time period (e.g., ten (“10”) seconds). As an example, the electronic apparatus may carry out an analysis operation which will be described below based on about forty (“40”) analysis results. According to embodiments, the analysis results may be referred to as determination results and categorization results, but embodiments are not limited thereto. However, the time, number of times, and number as described above are merely examples, and at implementation, different values may be used according to an application environment and specification and the like of the electronic apparatus.

The electronic apparatus may aggregate currently analyzed results and analysis results within a certain time period, and determine whether the current video corresponds to a first genre or corresponds to another genre at operation 430.

For example, if the most common result from among analysis results within a certain time indicates a category corresponding to sports videos (e.g., the first category), the electronic apparatus may determine a current genre of the current video to be a sports genre (e.g., may classify the current video as being included in the sports genre). According to embodiments, if the current analysis result indicates a category corresponding to close-up videos (e.g., the second category), the current genre may be determined as the sports genre if the previous analysis result is the category corresponding to sports videos (e.g., the first category), and may be determined as the other genre if the previous analysis result is the category corresponding to other videos (e.g., the third category).

The electronic apparatus may correct the video (e.g., perform image processing) based on the categorization result at operation 440. For example, for videos corresponding to the sports genre, a correction of increasing brightness, or increasing sharpness, or increasing factors corresponding to contrast in the video may be performed, and correction may be performed using control factor setting values that correspond to sports.

In the example described above, various types of sports are included in as one category, and an embodiment has been shown and described as performing the above-described correction, but embodiments are not limited thereto. For example, in some embodiments, the particular types of sports may be distinguished from each, and video correction corresponding to the particular sports types may be performed. For example, the electronic apparatus may classify the video into specific sub-genres such as a baseball sub-genre and a soccer sub-genre. Accordingly, the electronic apparatus may perform video correction using a first method based on the current video corresponding to the baseball sub-genre, and may perform video correction using a second method based on the current video corresponding to the soccer sub-genre.

As described above, because the electronic apparatus according to embodiments of the disclosure carries out categorization as a separate item for screens that are included in sports, and also for screens that do not have the features categorized as sports, a more accurate and consistent video categorization may be carried out.

Examples of characteristics of the category including close-ups, and the like in the disclosure are described below.

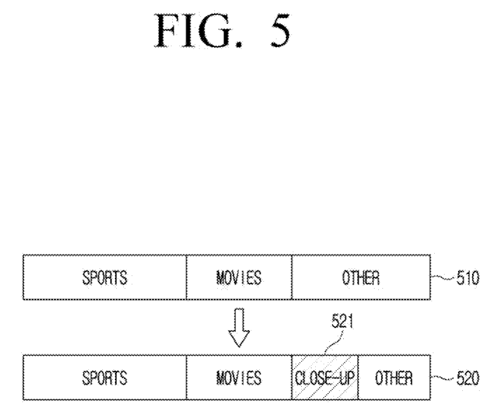

FIG. 5 is a diagram illustrating category items according to an embodiment of the disclosure.

Referring to FIG. 5, two categorization methods are shown. For example, a first categorization method 510 corresponding to a first method may categorize a video including the first feature corresponding to the sports genre as a first item based on the first feature, may categorize a video including the second feature corresponding to a movies genre as a second item based on the second feature, and may categorize a video that does not include the first feature and the second feature as a third item (e.g. other).

In the example shown, the video may be categorized or classified into the two genres (a sports genre and a movies genre) because there may be a method for correcting a specific image quality with respect to sports, and there may be another method for correcting a specific image quality with respect to movies.

As an example, because video processing such as raising screen brightness or raising sharpness may be carried out for the sports genre, the above-described video processing may be performed for videos that are categorized as a sports genre. Then, a separate image quality correction may not be applied with respect to the movies genre. For example, there may be instances in which the screen brightness is dark or the sharpness is low, but a processing method which does not correct the image quality if possible and allows for the video to be displayed as it may be used considering that the issues described may be intended by the director and the like.

According to the first categorization method 510, some videos that should be categorized as sports, but do not include the particular features corresponding to the sports genre, may be categorized as the other genre. For example, when a close-up screen of a player is shown during a sports game, or the crowd is shown, features (e.g., green grass, stadium, etc.) corresponding to the sports genre may not be detected in the current video, and the current video may therefore be categorized as the other genre.

Therefore, because close-up videos of a specific player or videos with crowds may frequently appear in sports videos, even though features corresponding to the sports genre may not be present, it may be beneficial to carry out additional categorizations for the above-described instances.

A second categorization method 520 described below involves a method of carrying out the above-described additional categorization. For example, the second categorization method 520 categorizes as separate items using the features associated with the above-described close-up video, crowd video, graphic image, and the like from among the videos that would be mistakenly categorized as the other genre in the first categorization method 510.

According to embodiments, because the second categorization method 520 may be the same as the first categorization method 510 for videos categorized in the sports genre and the movies genre, the second categorization method 520 may be implemented using a combination of a first neural network model that performs the first categorization method 510, and a second neural network model that further categorizes the videos categorized as the other genre by the first neural network model into a close-up genre and the other genre.

Although examples are described above with reference to FIGS. 1 and . 2 in which one neural network is used to distinguish between the first genre (e.g., the sports genre), the second genre (e.g., the movies genre) and the third genre (e.g., the other genre), embodiments are not limited thereto. For example, in some embodiments, the neural network may distinguish between only the first genre and the other genre. For example, the electronic apparatus may use a model that is trained for each specific genre. According to embodiments, the electronic apparatus may identify sports content using metadata and the like, and then may use model that is trained to distinguish categorize current videos included in the sports content as sports videos, close-up videos, and other videos.

Although examples are described which relate to sports such as baseball and soccer, embodiments are not limited thereto. For example, in some embodiments, it may be possible to carry out a specific video processing by categorizing gaming tournaments (e.g., electronic sports or e-sports) into the sports genre. In addition, it may be possible to distinguish a video of a game tournament being watched by a user from a video of a game being played by the user, and to carry out the specific video processing corresponding to a gaming genre for the video of the game being played by the user. For example, in the case of the gaming genre, the electronic device may be configured to perform video processing optimized for faster processing speed rather than increased image quality.

Although examples are described above in which analysis is performed using only video embodiments are not limited thereto. For example, in some embodiments, videos may be categorized using other information in addition to the video analysis, examples of which are described below with reference to FIG. 5 to FIG. 8.

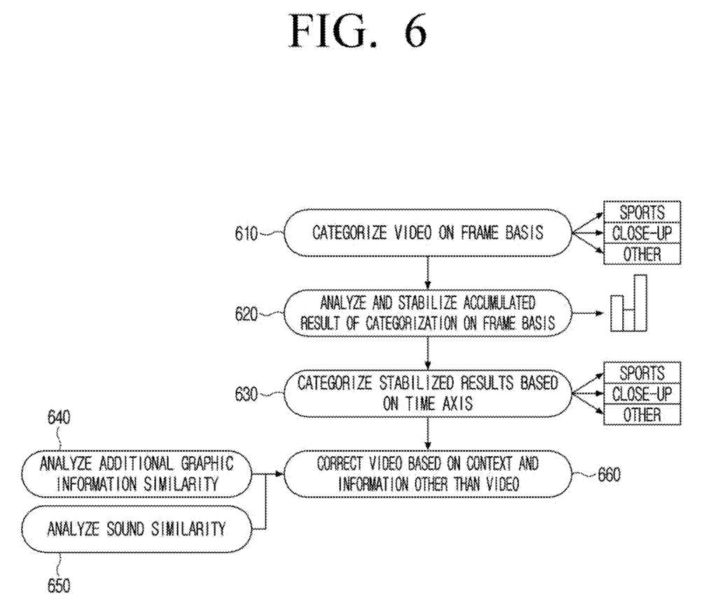

FIG. 6 is a diagram illustrating a categorization method according to an embodiment of the disclosure. Specifically, FIG. 6 illustrates an example for using additional information in the categorization method described in FIG. 4.

Referring to FIG. 6, the electronic apparatus may obtain the probability information by inputting the current video in the neural network model at operation 610. Operation 610 may be same as, or similar to operation 410 described above, and redundant descriptions thereof may be omitted.

The electronic apparatus may continuously accumulate and record the output results of the neural network model in the memory at operation 620. Then, the electronic apparatus may aggregate the currently analyzed result and the analysis results within a certain time period, and determine whether the current video corresponds to the first genre or corresponds to another genre at operation 630.

In FIG. 6, whether the additional graphic information is similar and sound similarity may be analyzed additionally at operation 640 and operation 650, and the video may be corrected by additionally using the two analysis results at operation 660.

For example, a video corresponding to the sports genre may continuously display additional graphic information such as a sports logo, game score, and the like at a certain position of the screen such as an left upper portion or an right upper portion. The additional graphic information as described may be displayed while a video including the first feature is being displayed, and may also continue to be displayed while displaying a close-up screen or a screen including the crowd.

Accordingly, the electronic apparatus may identify the current video as the sports video when it is determined that, despite being categorized as the close-up, the additional graphic information such as the game score, the sports logo and the like were displayed on the previous screen and maintained on the current screen.

The electronic apparatus may also check sound at operation 650. For example, if a specific player scores a goal during a soccer game, a close-up screen of the relevant player may be shown, and the cheering crowd may be shown. In this case, the cheering sound of the crowd may be continuously output in the relevant content. Accordingly, if the video displays the close-up screen or the crowd screen, the electronic apparatus may identify the current video as the sports video if the cheering sound was output along with in the previous screen and continues to be output along with the current screen.

Although examples are described in which both the additional graphic information and sound information are considered, embodiments are not limited thereto, and some embodiments may consider only one of the two.

In addition, although examples are described in which the additional graphic information is analyzed as a separate item, embodiments are not limited thereto. For example, in some embodiments, the neural network model described above may calculate probability value information by item based on whether the additional graphic information is present during the genre analysis process.

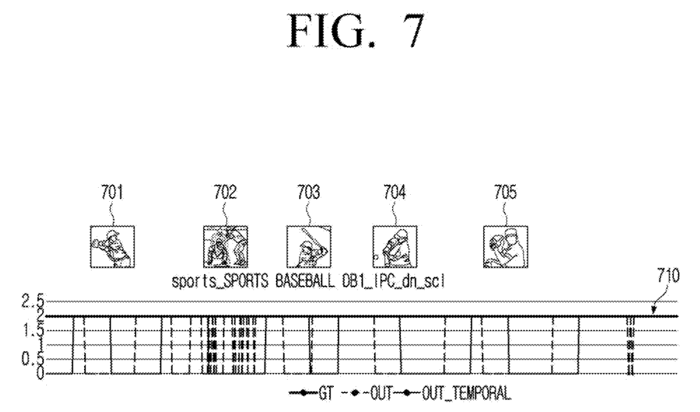

FIG. 7 is a diagram illustrating category examples according to an embodiment of the disclosure. Specifically, FIG. 7 illustrates various screen examples in a baseball screen corresponding to the sports genre and a categorization example thereof.

Referring to FIG. 7, the various screens in the baseball screen may be displayed in temporal order. As an example, a first screen 701, a third screen 703, a fourth screen 704, and a fifth screen 705 may be images showing close-ups of specific persons, and may be examples of screens without features that can be identified as sports. Further, a second screen 702 may be an image with the composition that can be identified as the baseball screen.

Before displaying the first screen 701, the electronic apparatus may determine that the current video corresponds to the sports genre. Then, when the first screen 701 is displayed, the electronic apparatus may categorize the current screen as a close-up screen. According to some approaches which may categorize the close-up screen as corresponding to the other genre, if the first screen 701 is displayed for a certain time or more, the current video may be determined not to correspond to the sports genre.

However, according to the disclosure, because the close-up screen may be categorized and processed as a separate item different the other (e.g., because the first screen 701 may be determined to correspond to the second category), even if the first screen 701 is maintained for a certain time after the current video is determined to correspond to the sports genre, the electronic apparatus may continue to determine that the current video corresponds to the sports genre.

Then, if the second screen 702 including the feature categorized as sports is output thereafter, the neural network model may output probability value information that includes a probability value corresponding to the first genre (e.g., the sports genre) with respect to the corresponding screen, and the electronic apparatus may categorize the current video as corresponding to the sports genre.

According to some approaches which may categorize the close-up screen as corresponding to the other genre, if close-up screens of specific persons (e.g., the third screen 703, the fourth screen 704, and the fifth screen 705) are displayed thereafter, (e.g., if the close-up screens are continuously maintained for a certain time or more) the current video may be determined to not correspond to the sports genre.

However, according to embodiments of the disclosure, the close-up screen may be distinguished as a specific category (e.g., the second category), and in this case, because the genre determination of the previous screen is maintained, the current video may be identified as continuously displaying the sports video even if the close-up screen is maintained for a certain time.

According to embodiments of the disclosure, because the close-up screen is categorized as a separate item and not the other as described above, and based on the previous category result being maintained when categorizing the close-up, the categorization result as the sports genre may be maintained even when the close-up screen is continuously maintained for a certain time.

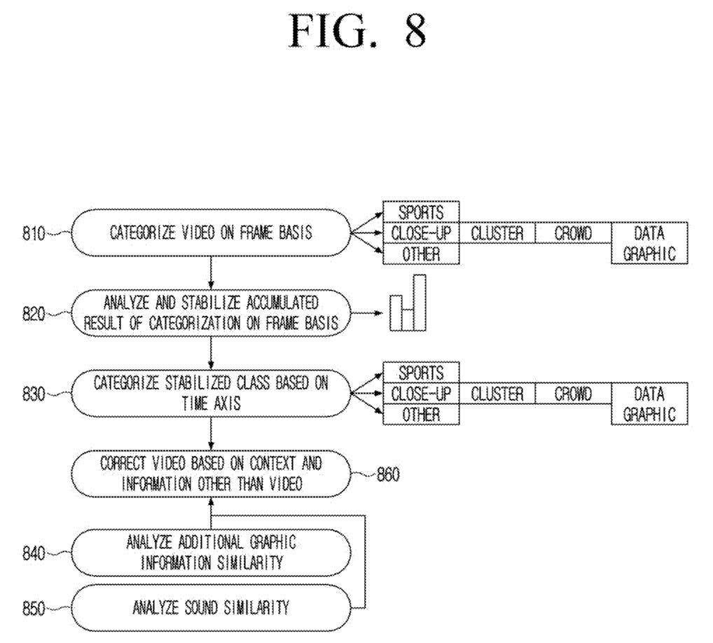

FIG. 8 is a diagram illustrating a categorization method according to an embodiment of the disclosure.

Referring to FIG. 8, the electronic apparatus may obtain the probability information by providing the current video as input the neural network model at operation 810. In the example illustrated in FIG. 8, categorization as separate features may be carried out for situations involving not only close-up screens, but for also for screens including clusters, crowds, data graphics, and the like. Although the example illustrated in FIG. 8 includes four such situations, embodiments are not limited thereto, and embodiments may be applied to other situations in addition to the above-described examples.

The electronic apparatus may continuously accumulate and record the output results of the neural network model in the memory at operation 820.

Then, the electronic apparatus may aggregate the currently analyzed results and analysis results within a certain time in the past, and determine whether the current video corresponds to the first genre or corresponds to another genre at operation S830. For example, the electronic apparatus may determine the current video corresponds to a close-up video, a cluster video, or a crowd video may be identified.

In addition, the electronic apparatus may additionally analyze whether the additional graphic information is similar at operation 840, and may additionally analyze the sound similarity at operation 850, and perform the final categorization and video correction by additionally using the two analysis results at operation 860.

Although examples are described in which various additional categories are applied to the scenario of FIG. 6, embodiments are not limited thereto. For example, in some embodiments, the various additional categories to be applied to the scenario of FIG. 4.

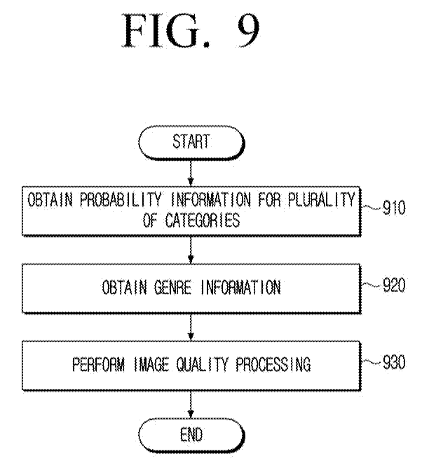

FIG. 9 is a flowchart illustrating a control method of an electronic apparatus according to an embodiment of the disclosure.

Referring to FIG. 9, at operation 910, the video may be provided as input to the neural network model, and the probability information may be obtained for the plurality of categories including the first category corresponding to the first genre and the second category corresponding to the plurality of genres. According to embodiments, the second category may not always be categorized as the first genre, but may have a possibility of being categorized as the first genre. According to embodiments, the neural network model may be a model trained to output probability values for each of the first category, the second category, and a third category. According to embodiments, the first category may be associated with a first feature corresponding to the first genre, the second category may not be associated with the first feature and may be associated with a second feature, and the third category that may not be associated with the first feature and the second feature.

Here, the first genre may be the sports genre, and the second category may be associated with at least one from among the close-up video showing a close-up screen of a specific person, the crowd video in which a plurality of persons is clustered, and the data graphic video. Accordingly, the above-described first feature may be the feature for identifying a plurality of sports, and may be, for example, detection of the grass environment for soccer, the composition of the home plate for baseball, the composition of the batter and the catcher being disposed, and the like.

Then, at operation 920, the genre information corresponding to the current video may be obtained based on the obtained probability information and the genre information corresponding to the previous frame. For example, based on the probability information corresponding to the first category being greater than or equal to the predetermined value, the genre may be determined as the first genre, and based on the probability information corresponding to the first category being less than the predetermined value and the probability value corresponding to the second category being the highest among probability values included in the probability information, the genre determined in the previous frame may be maintained. In some embodiments, the genre information may be determined based on a modal value from among the a plurality of probability values associated with one or more genres corresponding to a predetermined number of frames and a genre corresponding to a highest probability value included in the probability information.

According to embodiments, the electronic apparatus may further obtain the additional graphic information from the video, and obtain the genre information corresponding to the current video based on the obtained probability information and the genre information about the previous frame, whether the additional graphic information was obtained from the previous frame, and whether the additional graphic information was obtained from the current video. Although examples are described above in which the additional graphic information is considered in a separate step, embodiments are not limited thereto. For example, the network for genre analysis described above may perform genre analysis while taking the additional graphic information into account. Here, the additional graphic information may include at least one from among the broadcasting company logo, the sports federation logo, and the score status information that is positioned at the predetermined position of the video.

In addition, audio information may be used. For example, audio information corresponding to the video may be obtained, audio characteristic information may be obtained based on the audio information, and the genre information corresponding to the current video may be obtained based on the obtained probability information and the genre information about the previous frame, the audio characteristic information from the previous frame, and the audio characteristic information corresponding to the current video.

Then, image quality processing corresponding to the obtained genre information may be performed with respect to the current video.

As described, the video performed with the image quality processing may be displayed in the display device. If the electronic apparatus includes the display, the above-described image quality processed video may be displayed in the internal display. If the electronic apparatus is the set top box, the image quality processed video may be transmitted to an external display device.

Although examples are shown and described above in which history information is transmitted to the outside (e.g., to an outside of the electronic apparatus), embodiments are not limited thereto. For example, in some embodiments, the electronic apparatus may obtain associated information and a content list from the outside opposite to that above, and directly identify the recommended content by performing the operations as in FIG. 9.

As described, although the control method according to embodiments of the disclosure may analyze a genre of the current screen as the first genre from among the close-up video, the crowd video, and the graphic video, the screen that does not include the features of the first genre may not analyzed as a different genre, and in the above-described instance, the previously analyzed genre may be additionally considered to analyze the final genre, a more accurate and consistent genre analysis may be possible and a more accurate and consistent image quality processing may be performed accordingly.

According to embodiments, methods according to at least some from among the various embodiments of the disclosure described above may be implemented in an application form installable in electronic apparatuses of the related art.

In addition, the methods according to at least some from among the various embodiments of the disclosure described above may be implemented with only a software upgrade, or a hardware upgrade for the electronic apparatuses of the related art.

In addition, the methods according to at least some from among the various embodiments of the disclosure described above may be performed through an embedded server provided in an electronic apparatus, or at least one external server from among the electronic apparatuses.

Meanwhile, according to an embodiment of the disclosure, the various embodiments described above may be implemented with software including instructions stored in a machine-readable storage media (e.g., a computer). The machine may call stored instructions from a storage medium, and as a device operable according to the called instruction, may include the electronic apparatus (e.g., electronic apparatus (A)) according to the above-mentioned embodiments. Based on a command being executed by the processor, the processor may directly or using other elements under the control of the processor perform a function relevant to the command. The command may include a code generated by a compiler or executed by an interpreter. The machine-readable storage media may be provided in a form of a non-transitory storage medium. Herein, non-transitory merely means that the storage medium is tangible and does not include a signal, and the term does not differentiate data being semi-permanently stored or being temporarily stored in the storage medium. As an example, the non-transitory storage medium may include a buffer in which data is temporarily stored. According to an embodiment, a method according to the various embodiments disclosed herein may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online (e.g., downloaded or uploaded) through an application store (e.g., PLAYSTORE™) or directly between two user devices (e.g., terminal devices). In the case of online distribution, at least a portion of the computer program product (e.g., downloadable app) may be stored at least temporarily in the machine-readable storage medium such as a server of a manufacturer, a server of an application store, or a memory of a relay server, or temporarily generated.

Various embodiments of the disclosure may be implemented with software including instructions stored in a machine-readable storage media (e.g., computer). The machine may call the stored instructions from the storage medium, and as a device operable according to the called instructions, may include the electronic apparatus (e.g., electronic apparatus 100) according to the above-mentioned embodiments.

Based on the above-described instructions being executed by the processor, the processor may directly or using other elements under the control of the processor perform a function corresponding to the instructions. The instructions may include a code generated by a compiler or executed by an interpreter.

While some embodiments of the disclosure are illustrated and described above, it will be understood that the embodiments are intended to be illustrative, not limiting. It will be understood by those skilled in the art that various changes in form and details may be made therein without departing from the true spirit and full scope of the disclosure, including the appended claims and their equivalents.

What is claimed is:

1. An electronic apparatus, comprising:
a communication interface;
one or more processors; and
memory storing at least one instruction which, when executed by the one or more processors, causes the electronic apparatus to:
obtain a video using the communication interface;
obtain probability information for a plurality of categories by providing the video as input to a neural network model, wherein the plurality of categories comprises a first category corresponding to a first genre and a second category corresponding to a plurality of genres,
determine current genre information corresponding to a current video based on the obtained probability information and previous genre information corresponding a previous frame, and
perform image quality processing corresponding to the genre information on the current video.

2. The electronic apparatus of claim 1, wherein the neural network model is trained to output a probability value for each of the first category, the second category, and a third category,
wherein the first category is associated with a first feature corresponding to the first genre,
wherein the second category is associated with the first feature, and is not associated with a second feature, and
wherein the third category is not associated with the first feature and the second feature.

3. The electronic apparatus of claim 2, wherein the first genre comprises a sports genre, and
wherein the second category is associated with at least one from among a close-up video showing a close-up of a specific person, a crowd video in which a plurality of persons are clustered, and a data graphic video.

4. The electronic apparatus of claim 1, wherein the neural network model is trained to categorize sport events, and
wherein the second category is associated with different video conditions corresponding to a plurality of sport types.

5. The electronic apparatus of claim 1, wherein the at least one instruction, when executed by the one or more processors, further causes the electronic apparatus to:
obtain additional graphic information from the video, and
determine the genre information corresponding to the current video further based on a determination about whether the additional graphic information is obtained from the previous frame, and a determination about whether the additional graphic information is obtained from the current video.

6. The electronic apparatus of claim 5, wherein the additional graphic information comprises at least one from among a broadcasting company logo, a sports federation logo, and score status information at a predetermined position in the video.

7. The electronic apparatus of claim 1, wherein the at least one instruction, when executed by the one or more processors, further causes the electronic apparatus to:
obtain audio information corresponding to the video,
obtain audio characteristic information based on the audio information, and
determine the genre information corresponding to the current video further based on previous audio characteristic information corresponding to the previous frame, and current audio characteristic information corresponding to the current video.

8. The electronic apparatus of claim 1, wherein the at least one instruction, when executed by the one or more processors, further causes the electronic apparatus to:
determine a genre of the current video to be the first genre based on the probability information indicating that a first probability value corresponding to the first category is greater than or equal to a predetermined value, and
maintain the genre of the current video as a previous genre corresponding to the previous frame based on the probability information indicating that the first probability value is less than the predetermined value, and that a second probability value corresponding to the second category is a highest probability value included in the probability information.

9. The electronic apparatus of claim 1, wherein the at least one instruction, when executed by the one or more processors, further causes the electronic apparatus to:
determine the current genre information based on a modal value from among probability values associated with genres corresponding to a predetermined number of frames and a genre corresponding to a highest probability value included the probability information.

10. The electronic apparatus of claim 1, further comprising:
a display,
wherein the at least one instruction, when executed by the one or more processors, further causes the electronic apparatus to:
control the display to display the processed video.

11. A control method of an electronic apparatus, comprising:
obtaining, by providing a video as input to a neural network model, probability information for a plurality of categories comprising a first category corresponding to a first genre and a second category corresponding to a plurality of genres;
determining genre information corresponding to a current video based on the probability information and genre information of a previous frame; and
performing image quality processing corresponding to the genre information on the current video.

12. The method of claim 11, wherein the neural network model is a model trained to output probability values for each of the first category, the second category, and a third category,
wherein the first category is associated with a first feature corresponding to the first genre,
wherein the second category is not associated with the first feature, and is associated with a second feature, and
wherein the third category is not associated with the first feature and the second feature.

13. The method of claim 12, wherein the first genre comprises a sports genre, and
wherein the second category is associated with at least one from among a close-up video showing a close-up of a specific person, a crowd video in which a plurality of persons are clustered, and a data graphic video.

14. The method of claim 11,
wherein the neural network model is trained to categorize sport events, and
wherein the second category is associated with different video conditions corresponding to a plurality of sport types.

15. The method of claim 11, further comprising:
obtaining additional graphic information from the video, and
wherein the genre information is further obtained based on a determination about whether the additional graphic information is obtained from the previous frame, and a determination about whether the additional graphic information is obtained from the current video.

16. The method of claim 15,
wherein the additional graphic information comprises at least one from among a broadcasting company logo, a sports federation logo, and score status information at a predetermined position in the video.

17. The method of claim 11, further comprising:
obtaining audio information corresponding to the video,
obtaining audio characteristic information based on the audio information, and
wherein the genre information is further obtained based on previous audio characteristic information corresponding to the previous frame, and current audio characteristic information corresponding to the current video.

18. The method of claim 11, further comprising:
determining a genre of the current video to be the first genre based on the probability information indicating that a first probability value corresponding to the first category is greater than or equal to a predetermined value, and
maintaining the genre of the current video as a previous genre corresponding to the previous frame based on the probability information indicating that the first probability value is less than the predetermined value, and that a second probability value corresponding to the second category is a highest probability value included in the probability information.

19. The method of claim 11, further comprising
wherein the genre information is further obtained based on a modal value from among probability values associated with genres corresponding to a predetermined number of frames and a genre corresponding to a highest probability value included the probability information.

20. A non-transitory computer-readable recording medium storing programs for executing a control method of an electronic apparatus, the method comprising:
obtaining, by providing a video as input to a neural network model, probability information for a plurality of categories comprising a first category corresponding to a first genre and a second category corresponding to a plurality of genres;
determining genre information corresponding to a current video based on the probability information and genre information of a previous frame; and
performing image quality processing corresponding to the genre information on the current video.
